(19) United States
(12) Patent Application Publication
(10) Pub. No.: US 2017/0166271 A1
(43) Pub. Date: Jun. 15, 2017

(54) ROLLER SYSTEM FOR MACHINE UNDERCARRIAGE

(71) Applicant: CATERPILLAR INC., Peoria, IL (US)

(72) Inventors: David Jennings Hakes, Brimfield, IL (US); Roger Essley Lawson, Brimfield, IL (US)

(73) Assignee: CATERPILLAR INC., Peoria, IL (US)

(21) Appl. No.: 14/970,073

(22) Filed: Dec. 15, 2015

(51) Int. Cl. B62D 55/14; B62D 55/06; B62D 55/20

(52) U.S. Cl. CPC B62D 55/14; B62D 55/20; B62D 55/06; B62D 55/202; E02F 3/308

(57) ABSTRACT

A roller system for a tracked undercarriage is disclosed. The roller system includes an interconnected track shoe series. A first roller series is configured to engage a first plurality of non-adjacent track shoes of the interconnected track shoe series. A second roller series is configured to engage a second plurality of non-adjacent track shoes of the interconnected track shoe series. Rollers of the first roller series are independently mounted relative to rollers of the second roller series. Non-adjacent track shoes of the first plurality are between non-adjacent track shoes of the second plurality.

### TECHNICAL FIELD

The present disclosure is directed to a machine undercarriage and, more particularly, is directed to a roller system for a machine undercarriage.

### BACKGROUND

Many machines, such as, for example, tractors, dozers, hydraulic excavators, mining machines, and other earth or material moving machines, include tracked undercarriages to facilitate movement of the machines over a ground surface, a tracked undercarriage may include a pair of track assemblies with one track assembly on each side of the machine. A track assembly may include a track frame on which is mounted a drive sprocket, one or more idlers, and guiding structure to drive and support an endless track. An endless track generally includes a series of interconnected track shoes with each track shoe including a ground engaging surface and a support surface for the rollers opposite the ground engaging surface. The length of each track shoe along the endless track from its connection to an adjacent track shoe on one end to its connection to an adjacent track shoe on the other end is typically referred to as a pitch.

A plurality of track rollers typically are mounted to the track frame and contact the support surface of track shoes along a lower, ground engaging run of the endless track. Track rollers may be symmetric relative to the width direction of the endless track and may include paired, side-by-side contact surfaces that engage the support surfaces of the track shoes along paired, side-by-side support surfaces. Load forces of the machine are transferred through the undercarriage, to the track frame, to the track rollers, to the track itself, and finally to the ground. The plurality of track rollers may be spaced close together along the support surfaces of the lower run of the endless track. Given space constraints and the necessary size of the rollers for adequate machine support, a typical machine may include between six and eight track rollers, for example, but also may include less than six or more than eight.

These rollers, while closely spaced, still have their axes of rotation spaced apart greater than one pitch of the endless track. The diameter and spacing of the rollers generally is such that the center-to-center spacing between track rollers averages about 1.6 times one pitch of the endless track (or the length of a track section, or the center-to-center spacing between track shoes). This results in a track platform that is only about 65% efficient. Track platform efficiency is defined as the total number of bottom rollers divided by the total number of shoes engaging the ground (between the first and last roller). A track platform efficiency that is too low causes track shoes to be stressed unevenly and not used productively for machine support since each track shoe is not simultaneously and uniformly engaged by a track roller, in addition, a track platform efficiency that is too low results in fewer lateral (or thrust) contact points between the rollers and track shoes. This diminishes track guiding, whereby the track can more easily leave the rollers (known as de-railing or de-tracking) during a machine turn or machine operation on uneven terrain. Track de-railing can result in significant damage to undercarriage components. A track platform efficiency that is too low creates additional problems in the undercarriage system. One of these problems is increased machine vibration caused by the undercarriage at higher travel speeds. This machine vibration is mostly a function of machine travel speed, stiffness of the ground, the space between rollers, and the pitch of the track. An additional problem with a track platform efficiency that is too low is the increased space between any two adjacent rollers which causes excessive shoe-to-shoe back bending between these rollers. When track shoes back bend excessively, high loads and corresponding stresses occur in the track joints and at the forward and aft edges of the shoes.

There exists a need to increase efficiency of the track platform, such that more roller contacts with the shoes will (1) improve vertical load distribution to the ground, (2) improve lateral track guiding capability, (3) lower track induced machine vibration at higher travel speeds, and (4) reduce shoe-to-shoe hack bending between any two adjacent rollers.

One type of roller system is disclosed in U.S. Pat. No. 4,422,696 issued to Seit on Dec. 27, 1983 (“the '696 patent”). The '696 patent discloses a track structure that purports to address wear and tear on the suspension system of a tracked vehicle with a roller system intended to avoid the vertical oscillations that occur as the rollers, or wheels, tend to drop as the track links pass the rollers. The links of the track chain of the '696 patent include gaps between the adjacent links having a spacing “x,” The track rollers are mounted on “bogie assemblies” and include roller pairs, side-by-side adjacent, wherein the two rollers of a pair are offset inter-axially by a spacing “X.” According to the '696 patent, the relationship between “x” and “X” should be 1x≦X≦1.5x. With this relationship, according to the '696 patent, the two rollers of each pair of rollers are offset sufficiently so that one of the two rollers always will rest upon the fiat surface of a tread link and avoid a drop of the rollers as the track links pass by.

While the system of the '696 patent may be useful for some applications, it may not be adequate to address track wear and heavy machine support issues. The '696 patent discloses a slightly offset roller arrangement specifically to address a problem associated with a gap between track links. This is generally not an issue with construction or mining machine track where little or no such gap exists between adjacent links or shoes. The '696 patent does not adequately address the issue of evenly and uniformly distributing machine weight among ground engaging track shoes so as to maximize productive use of the track shoes. In addition, the '696 patent does not address the issue of reduced track guiding capability when some shoes on the ground do not contact a roller. Also, the '696 patent does not address excessive shoe-to-shoe back bending and excessively high loads and uneven wear that may be imposed against the track shoes on uneven ground where excessive space can exist between any two adjacent rollers.

The roller system for machine undercarriage of the present disclosure solves one or more of the problems set forth above and/or other problems of the prior art.

### SUMMARY

In one aspect, the present disclosure is directed to a roller system for a tracked undercarriage. The roller system includes an interconnected track shoe series. The roller system also includes a first roller series configured to engage a first plurality of non.-adjacent track shoes of the track shoe series. The roller system also includes a second roller series configured to engage a second plurality of non-adjacent track shoes of the track shoe series. The rollers of the first roller series are independently mounted relative to rollers of the second roller series, and non-adjacent track shoes of the first plurality are between non-adjacent track shoes of the second plurality.

In another aspect, the present disclosure is directed to a track assembly including a track frame. The track assembly also includes a drive sprocket and at least one take-up idler mounted on the track frame. The track assembly also includes an endless track that includes an interconnected track shoe series with the endless track mounted on the track frame and engaged with the drive sprocket and the at least one take-up idler. The track assembly also includes a first roller series configured to simultaneously engage a first plurality of track shoes of the track shoe series, and a second roller series configured to simultaneously engage a second plurality of track shoes of the track shoe series, and wherein the first plurality of track shoes is different from the second plurality of track shoes.

In yet another aspect, the present disclosure is directed to a machine. The machine includes an upper body including a power source. The machine also includes an undercarriage supporting the upper body and including a plurality of track assemblies with each track assembly including a track frame. The machine also includes an endless track mounted on the track frame of each track assembly and including an interconnected track shoe series. Each track assembly of the machine includes a first roller series in a linear array wherein each roller is secured to the track frame for rotation about an axis, and a second roller series in a linear array parallel to the first roller series wherein each roller is secured to the track frame for rotation about an axis, wherein the first roller series is offset longitudinally of the track frame relative to the second roller series such that the axes of the rollers of the first roller series are between the axes of the rollers of the second roller series.

### BRIEF DESCRIPTION OF THE DRAWINGS

FIG. 1 illustrates an exemplary machine including a tracked undercarriage according to a disclosed embodiment;

FIG. 2 is an enlarged side view of a track assembly and track roller system according to a disclosed embodiment;

FIG. 3 is an enlarged perspective view of a track assembly and track roller system according to a disclosed embodiment:

FIG. 4 is a diagrammatic side view of an embodiment of the disclosed track roller system;

FIG. 5 is a diagrammatic plan view of an embodiment of the disclosed track roller system;

FIG. 6 is a close-up side view of an embodiment of the disclosed track roller system; and

FIG. 7 is a simplified cross-sectional view of an embodiment of the disclosed track roller system.

### DETAILED DESCRIPTION

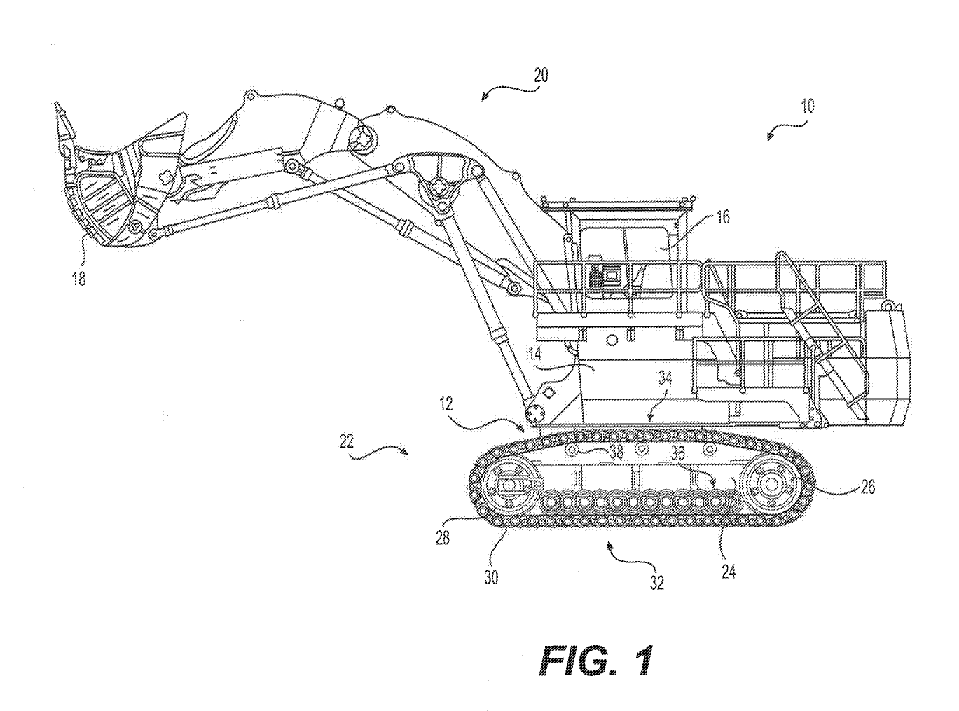

FIG. 1 illustrates an exemplary machine 10, adapted for excavating or mining earth, rock, ore, or other materials, and including a tracked undercarriage 12. Machine 10 may include a main frame or upper body 14 supported on undercarriage 12, and upper body 14 may include a cab 16 for housing a machine operator. Upper body 14 also may include a power source (not shown), such as an internal combustion engine, for example. An implement 18, such as a mining shovel, may be operatively connected to upper body 14 via a suitable boom system 20. While machine 10 is illustrated as a hydraulic mining shovel, it should be understood that the disclosed undercarriage may support various types of machines other than a hydraulic mining shovel such as, for example, electric rope shovels, hydraulic excavators, track type tractors, track type loaders, etc.

Undercarriage 12 may include a track assembly 22 on each side of machine 10, only one track assembly 22 being visible in FIG. 1. Track assembly 22 may include a track frame 24 that is fixed to undercarriage 12 and forms the supporting structure for a number of components of track assembly 22. Track frame 24 may include a drive sprocket 26 and a take-up idler 28. An endless track 30 may he mounted on track frame 24 and around drive sprocket 26 and take-up idler 28. Endless track 30 may include a lower run 32 in ground contact, and an upper run 34. Lower run 32 may be engaged by a track roller system 36 to be described in more detail subsequently. Upper run 34 may be engaged and supported by one or more top carrier rollers 38.

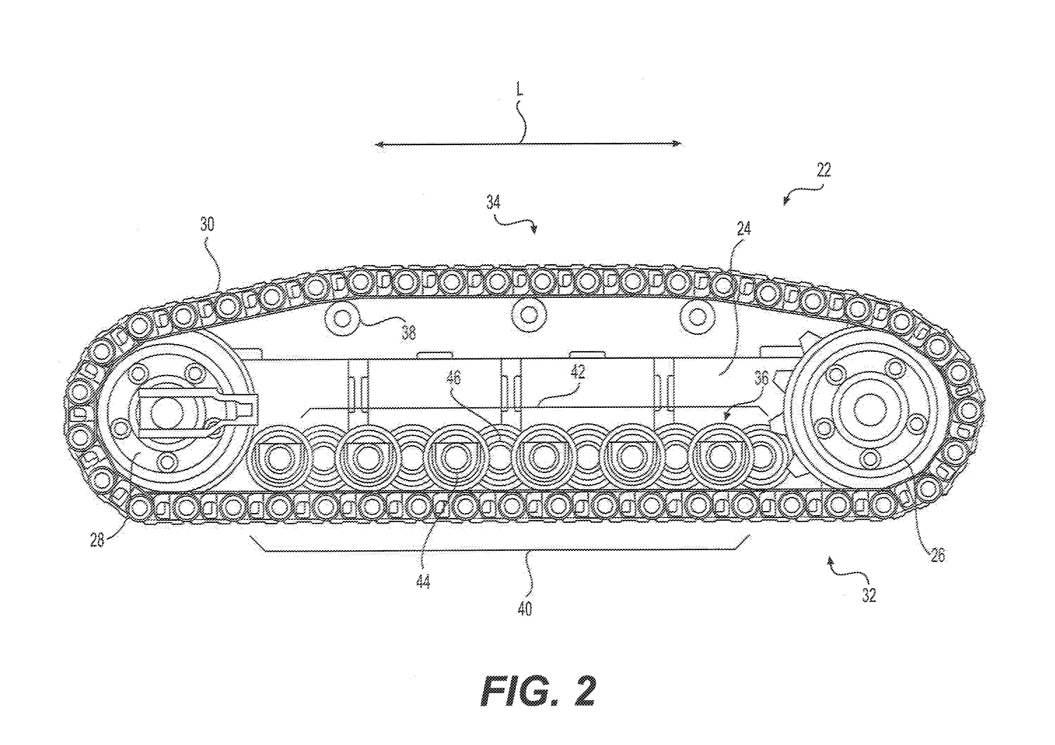

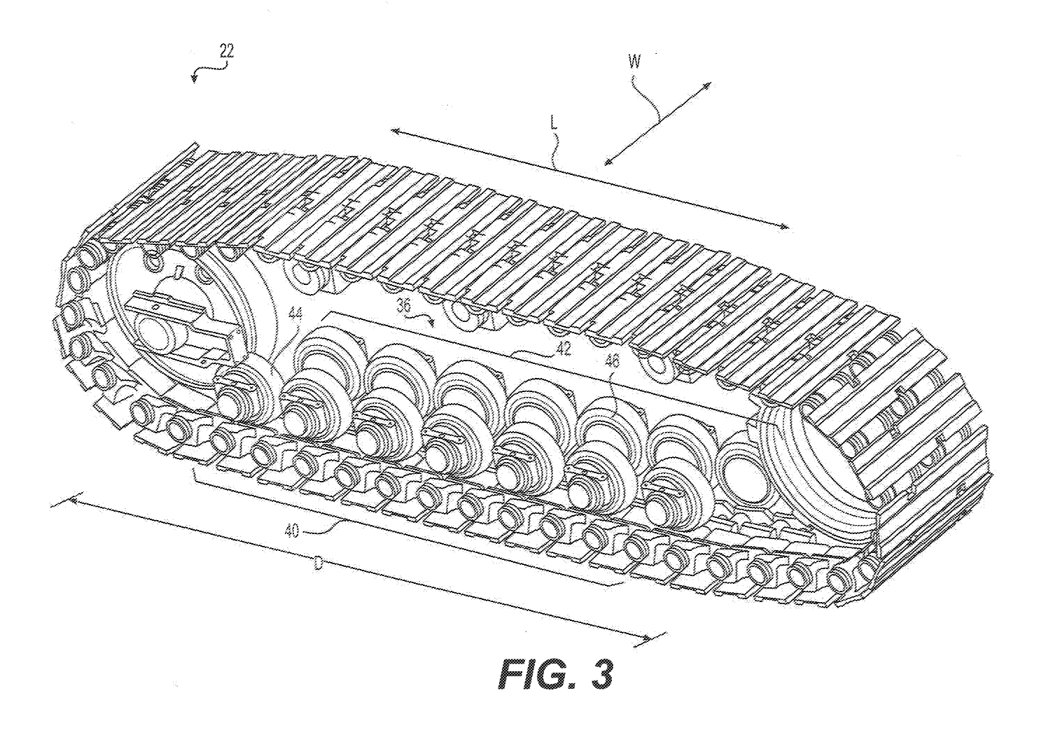

FIG. 2 is an enlarged, somewhat schematic side view of track assembly 22 isolated from machine 10 in order to illustrate components and aspects of track assembly 22 and track roller system 36. Track roller system 36 may include a first roller series 40 and a second roller series 42. First roller series 40 may include a first plurality of individual track rollers 44 that are substantially equally spaced along a length direction L of track assembly 22. Second roller series 42 may include a second plurality of individual track rollers 46 that are substantially equally spaced along the length direction L of track assembly 22. First roller series 40 may be laterally spaced from second roller series 42 in a width direction W (see FIG. 3) that is perpendicular to length direction L of track assembly 22, with rollers 44 of first roller series 40 independently mounted relative to rollers 46 of second roller series 42.

Each roller 44 of first roller series 40 may be spaced from an adjacent roller 44 such that the distance between the outside diameters of rollers 44 is less than the diameter of roller 44. Similarly, each roller 46 of the second roller series 42 may be spaced from an adjacent roller 46 such that the distance between the outside diameters of rollers 46 is less than the diameter of roller 46. The diameters of each of rollers 44 and rollers 46 may be substantially equal. As viewed in FIG. 2, adjacent rollers 44 of first roller series 40 overlap adjacent rollers 46 of second roller series 42. While the number of rollers 44 and 46 in a track roller system 36 may vary depending on the type and size of machine 10, FIG. 2 illustrates an example of a disclosed track roller system 36 that includes six rollers 44 in track roller series 40 and six rollers 46 in track roller series 42 for a total of twelve track rollers. It is contemplated that the number of rollers 44, 46 in each roller series 40, 42 may be between five and nine, although more or less may be employed in some machines.

FIG. 3 is a diagrammatic perspective view illustrating an embodiment of a disclosed track assembly 22 and track roller system 36. In FIG. 3, some components are not illustrated in order to provide a clearer view of the asymmetric arrangement of first and second roller series 40 and 42. Second roller series 42 may be asymmetric to first roller series 40 relative to a line extending in length direction L of track assembly 22 and between first roller series 40 and second roller series 42. First roller series 40 is illustrated laterally adjacent second roller series 42 in width direction W of track assembly 22. Each track roller 44 of first roller series 40 is longitudinally offset in length direction L from a laterally adjacent track roller 46 of second roller series 42. The combined distance D of first and second roller series 40 and 42 may be longer in the length direction L than either of roller series 40 or 42 by a distance approximately equal to the offset of a track roller 44 from a laterally adjacent track roller 46.

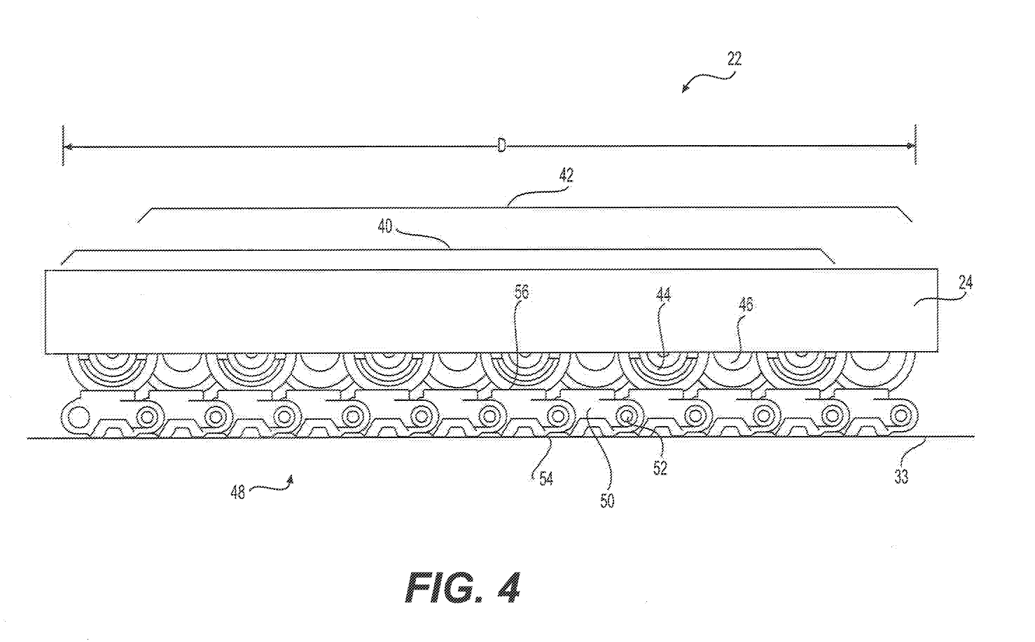

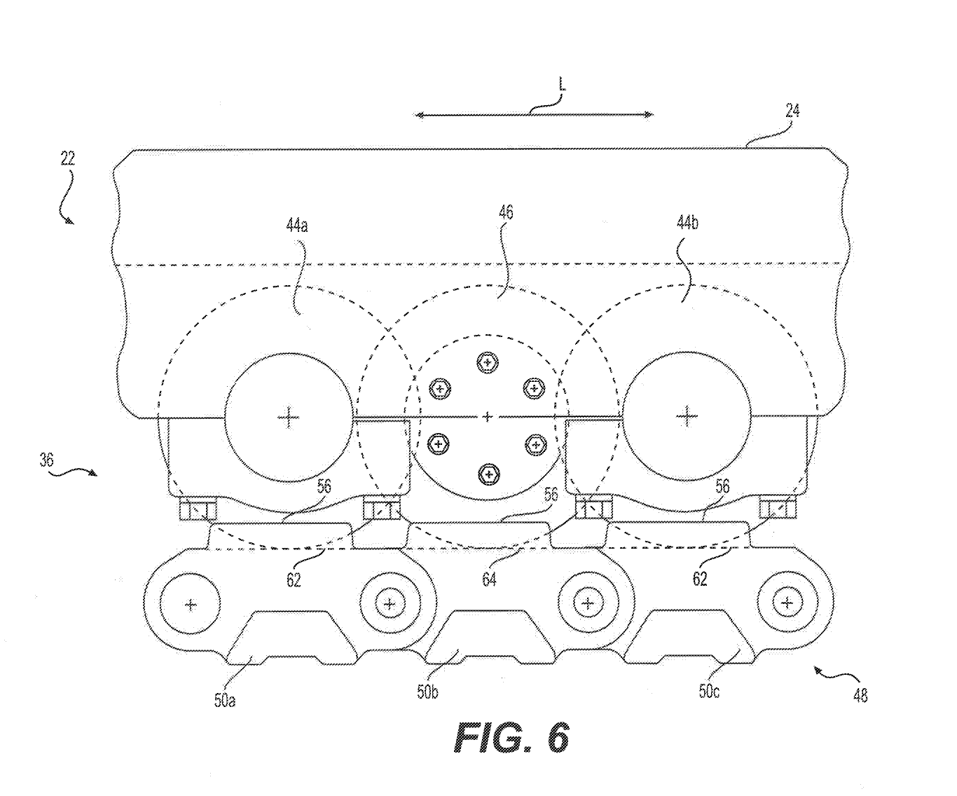

FIGS. 4-7 diagrammatically illustrate aspects of the disclosed track roller system 36 and relationships among various components of track assembly 22. FIG. 4 is a stylized side view of a portion of track assembly 22 illustrating track frame 24 and an interconnected track shoe series 48 of endless track 30 (FIGS. 1 and 2). Track shoe series 48 may include a plurality of substantially similar, interchangeable track shoes 50 that may be pivotally interconnected at joints 52. Track shoes 50 of track shoe series 48 may be in engagement with a ground surface 33 on a first surface 54 of each track shoe 50, and in engagement with track rollers 44, 46 on opposite rail surfaces 62 and 64 (FIG. 6) of each track shoe 50.

Rollers 44 of first roller series 40 may engage with portions of rail surfaces 62 and 64 of alternate track shoes 50 of track shoe series 48. Rollers 46 of second roller series 42 may engage with portions of rail surfaces 62 and 64 of different, alternate track shoes 50 that are adjacent and between alternate track shoes engaged by rollers 44. Stated differently, first roller series 40 may be configured to engage with a first plurality of non-adjacent track shoes 50 of track shoe series 48, and second roller series 42 may be configured to engage with a second plurality of non-adjacent track shoes 50 of track shoe series 48, with the first plurality of track shoes 50 being different from the second plurality of track shoes 50. Accordingly, along the combined distance D of first and second roller series 40 and 42 of track roller system 36, each track shoe 50 of track shoe series 48 may be simultaneously engaged by a roller 44 or 46 of first or second roller series 40, 42.

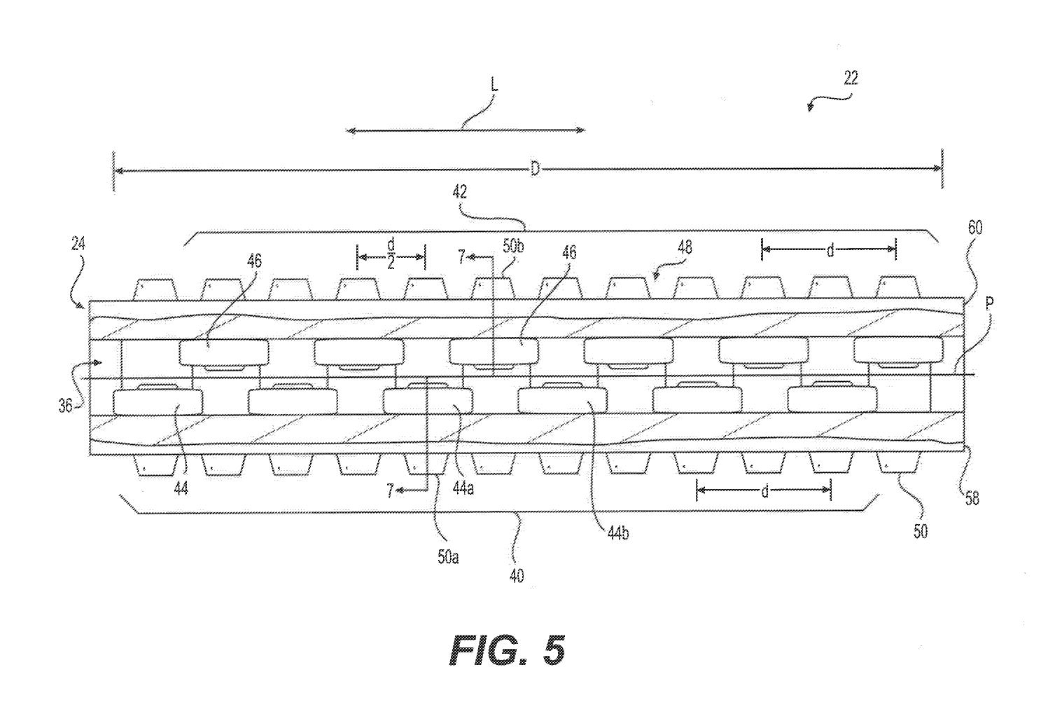

FIG. 5 is a stylized plan view of the portion of track assembly 22 illustrated in FIG. 4. Track frame 24 may include a first side 58, which may be located toward an outer surface of track assembly 22 and machine 10 (FIG. 1). Track frame 24 also may include a second side 60 located toward an inner surface of track assembly 22. First roller series 40 may be linear and mounted to first side 58, and rollers 44 may be in a first substantially linear array along length direction L. Second roller series 42 may be linear and mounted to second side 60, and rollers 46 may be in a second substantially linear array along length direction L laterally adjacent and substantially parallel to the first substantially linear array. Each individual roller 44, 46 may be mounted to a respective first or second side 58, 60 at only one roller side such that each individual roller 44, 46 is cantilevered from the respective first or second side 58, 60. Each track shoe 50 of track shoe series 48 is illustrated in the plan view of FIG. 5 below a roller 44 or 46 such that a roller 44 or 46 engages each successive track shoe 50 of track shoe series 48. Accordingly, the spacing between adjacent track shoes 50 of track shoe series 48 is substantially equal to the linear spacing in length direction L between any roller 44 of first roller series 40 and a laterally adjacent roller 46 of second roller series 42.

FIG. 5 illustrates the asymmetric aspect of track roller system 36. Line P designates a plane longitudinally, vertically, and centrally though track roller system 36 and along the length direction L of track assembly 22. In FIG. 5, first roller series 40 and second roller series 42 are asymmetric relative to the plane indicated by line P. More specifically, rollers 44 of first roller series 40 are offset longitudinally of track assembly 22 relative to rollers 46 of second roller series 42. In the embodiment illustrated in FIG. 5, for example, rollers 46 of second roller series 42 are located substantially equidistantly between laterally adjacent rollers 44 of first roller series 40, and rollers 44 are similarly located with respect to rollers 46.

As illustrated in FIG. 5, rollers 44 of first roller series 40 are laterally spaced from rollers 46 of second roller series 42 a distance that is sufficient to permit rollers 44 to overlap rollers 46 along the length direction L of track frame 24 and track assembly 22. Taken together, first roller series 40 and second roller series 42 may extend longitudinally along track assembly 22 for the combined distance D, as previously indicated in connection with the description of FIGS. 3 and 4. The outside diameter of each roller 44 of the first substantially linear array may be greater than the distance between adjacent rollers 44, and each roller 44 may be equidistantly spaced from adjacent rollers 44. Likewise, the outside diameter of each roller 46 of the second substantially linear array may be greater than the distance between adjacent rollers 46, and each roller 46 may be equidistantly spaced from adjacent rollers 46.

In FIG. 5, distance d is the center-to-center spacing, or distance between axes of rotation, of adjacent rollers 44 or 46. That is, the axes of adjacent rollers 44 of first roller series 40 are equally spaced apart by distance d along the first substantially linear array, and the axes of adjacent rollers 46 of second roller series 42 are equally spaced apart by the same distanced along the second substantially linear array. Taking first and second roller series 40, 42 together, the axes of rollers 44 of first roller series 40 are spaced apart along the combined distance D on the lower run 32 from the axes of rollers 46 of second roller series 42 by approximately half the distance d, or d/2.

FIG. 6 is a close-up side view of a portion of track assembly 2.2 and track roller system 36. The view in FIG. 6 illustrates two rollers 44a and 44b of first roller series 40 that are adjacent each other along length direction L longitudinally of track assembly 22 and track frame 24. Also illustrated is one roller 46 of second roller series 42 laterally adjacent (i.e., behind rollers 44a, 44b in FIG. 6) and between (i.e., along length direction L longitudinally of track assembly 22 and track frame 24) rollers 44a and 44b. Each roller 44a, 46, 44b is engaged with a successive, adjacent track shoe 50a, 50b, 50c, of track shoe series 48.

Roller 44a May engage with a first rail surface 62 and a guide surface 56 of track shoe 50a, roller 46 may engage with a second rail surface 64 and a guide surface 56 of track shoe 50b, and roller 44b may engage with a first rail surface 62 and a guide surface 56 of track shoe 50c. Accordingly, by extrapolation, adjacent rollers 44 of the first roller series 40 may be configured to engage first rail surfaces 62 and guide surfaces 56 of alternate, non-adjacent track shoes 50 of track shoe series 48, and adjacent rollers 46 of second roller series 42 may be configured to engage second rail surfaces 64 and guide surfaces 56 of track shoes 50 of track shoe series 48 that are between the alternate, non-adjacent track shoes 50.

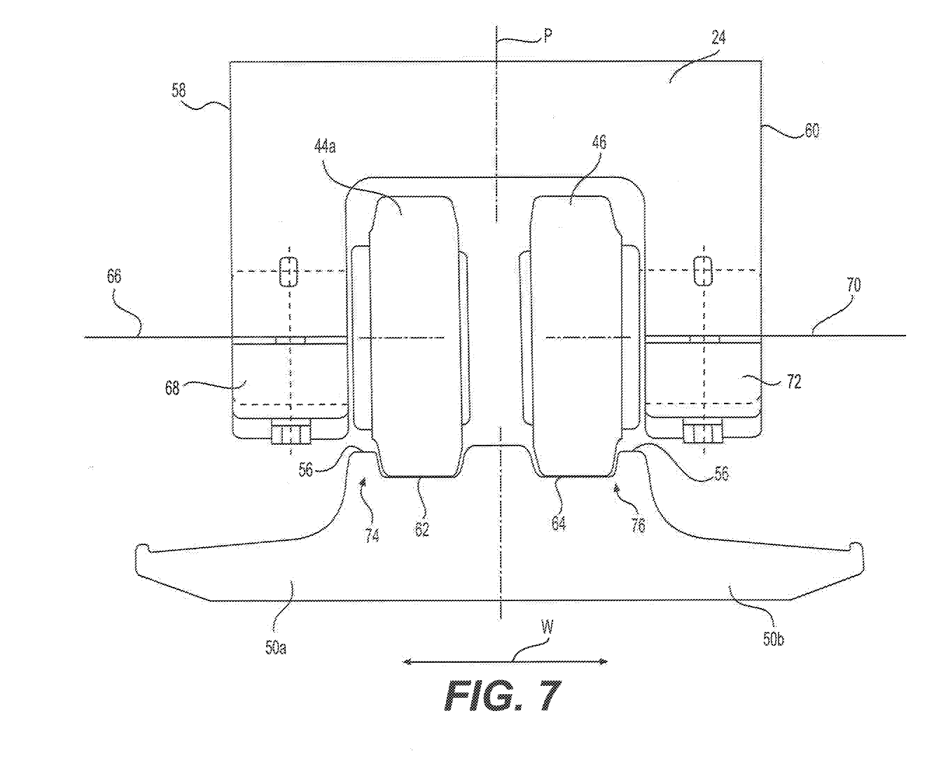

FIG. 7 is a cross-sectional view through track frame 24, first and second roller series 40, 42, and track shoe series 48 taken generally along the line 7-7 shown in FIG. 5 so as to illustrate certain aspects and relationships of components of track roller system 36. Referring back to FIG. 5, two adjacent track shoes have been designated track shoes 50a and 50b. Line 7-7 in FIG. 5 runs half way through track shoe 50a to line P, along line P to track shoe 50b, and then half way through track shoe 50b as indicated. It is along this line 7-7 that the cross-sectional view in FIG. 7 is taken. Rollers 44a, 46, and 44b that are illustrated and described in connection with FIG. 6 also are illustrated centrally of FIG. 5, and the line 7-7 runs through roller 44a of first roller series 40 and roller 46 of second roller series 42.

As viewed in FIG. 7, roller 44a may be cantilevered from first side 58 of track frame 24 for rotation about an axis 66. Roller 44a may be mounted to first side 58 via a cap 68 and suitable fasteners, for example. Roller 46 may be cantilevered from second side 60 of track frame 24 for rotation about an axis 70. Roller 46 may be mounted to second side 60 via a cap 72 and suitable fasteners similar to the mounting of roller 44a. While the axis 66 of rotation of roller 44a may be longitudinally spaced along the length direction L of track frame 24 from the axis 70 of rotation of roller 46, FIG. 7 illustrates that roller 44a and roller 46 are suitably spaced apart laterally of track frame 24 in width direction W so as to avoid interference and also permit the two rollers to overlap longitudinally along the length direction L of track frame 24 as illustrated in FIG. 6, for example.

FIG. 7 also illustrates relationship aspects of rollers 44 and 46 with track shoes 50. Roller 44a is in engagement with first rail surface 62 located within a groove 74 of track shoe 50a, Roller 46 is in engagement with second rail surface 64 located within a groove 76 of track shoe 50b, Each track shoe 50 may include two, side-by-side first and second rail surfaces 62, 64. First rail surfaces 62 may cooperate with and be engaged by rollers 44 of first roller series 40, and second rail surfaces 64 may cooperate with and be engaged by rollers 46 of second roller series 42. First rail surfaces 62 of each track shoe 50 interconnected in endless track 30 may engage all rollers 44 of first roller series 40 during a complete revolution of endless track 30. Likewise second rail surfaces 64 of each track shoe interconnected in endless track 30 may engage all rollers 46 of second roller series 42 during a complete revolution of endless track 30. Each roller 44, 46 of first and second roller series 40, 42 may be cantilevered from a respective first or second side 58, 60 of track frame 24 in a manner similar to rollers 44a and 46 described in connection with FIG. 7. Guide surface 56 (illustrated generally in FIGS. 4 and 6) may extend into and along the sides of grooves 74, 76.

### INDUSTRIAL APPLICABILITY

The disclosed track roller system may be employed in any track-type machine and may provide a number of advantages over conventional track roller systems. Conventional track roller systems typically include a symmetric track roller arrangement wherein each roller may include paired, side-by-side roller surfaces. The diameter of the rollers and the pitch of the track preclude certain shoes between any two adjacent rollers from having contact with a roller. This results in an inefficient track platform with an efficiency rating of about 65%. In the disclosed track roller system, each track shoe on the lower run of an endless track and along the length of the track roller system may be simultaneously and uniformly engaged by a roller. This results in two distinct advantages over the conventional roller system. First, vertical forces due to machine weight and machine operation may be more evenly distributed to the individual track shoes of the interconnected track shoe series engaged with the ground. This results in a track platform efficiency rating of 100%. Second, lateral forces due to machine turning or operation on uneven ground are also more evenly distributed to the individual track shoes.

The separate cantilever mounting of rollers to opposite sides of the track roller frame for engagement with the paired rail surfaces of the track shoes permits the asymmetric arrangement of the rollers, the resulting increase in the number of individual rollers, and the engagement of each track shoe substantially uniformly and simultaneously by an individual roller. The number of rollers in the track roller system is not limited by the size of the rollers to the same extent as in conventional systems. By having one roller for each track shoe, vertical machine support is increased. By having separate track roller series for each track shoe rail surface and a separate roller for each track shoe, better track guiding results with less chance of the track separating from the rollers. The asymmetric roller system also allows for farther reduction in adjacent roller to roller spacing beyond which is described in this disclosure. Further reduced roller spacing results in a track platform efficiency above 100%. This occurs when all shoes engaging the ground will have one or more roller contact points at any given point in time. Here, machine working loads are even more uniformly distributed onto the track platform that engages the ground.

Separate track roller series not only permits an arrangement of one roller for each track shoe, but also permits each roller to be larger in diameter than the length of a single track shoe with each roller of sufficient diameter to ensure adequate machine support. One roller for each track shoe prevents excessive shoe back bending between rollers. This reduces stress to track shoes and their pin joints, reducing damage to the track. One roller for each track shoe lowers track induced vibration during machine travel. Since one track roller contacts each track shoe along the lower run, there are no unproductive or partially productive track shoes. The efficiency of the track roller/track shoe system may be close to 100%.

A conventional track roller system comprising, for example, eight track rollers with paired, side-by-side roller surfaces will have sixteen wear points on track shoes along a lower run of twelve track shoes beneath the track roller system. By contrast, the disclosed asymmetric track roller system, for the same twelve track shoes beneath it, may have two, asymmetrically arranged track roller series of six track rollers each for a total of twelve track roller and only twelve wear points on the track shoes. Accordingly, the track shoe wear may be approximately 25% less than that which may occur with a conventional track roller system. For the same number of ground engaging track shoes beneath the track roller system, the wear points are reduced on each of the two rail surfaces from eight, for the conventional eight-roller system, to six for the disclosed asymmetric track roller system.

It will be apparent to those skilled in the art that various modifications and variations can be made in the disclosed roller system for machine undercarriage without departing from the scope of the disclosure. Other embodiments of the disclosed roller system for machine undercarriage will be apparent to those skilled in the art from consideration of the specification. It is intended that the specification and examples be considered as exemplary only, with a true scope of the disclosure being indicated by the following claims and their equivalents.

What is claimed is:

1. A roller system for a tracked undercarriage, comprising:
an interconnected track shoe series;
a first roller series configured to engage a first plurality of non-adjacent track shoes of the track shoe series; and
a second roller series configured to engage a second plurality of non-adjacent track shoes of the track shoe series;
wherein rollers of the first roller series are independently mounted relative to rollers of the second roller series, and non-adjacent track shoes of the first plurality are between non-adjacent track shoes of the second plurality.

2. The roller system of claim 1, wherein the number of rollers in each of the first and second roller series is between 5 and 9, and each track shoe of the track shoe series is simultaneously engaged by one roller of one of the first and second roller series.

3. The roller system of claim 1, including a track frame, and wherein the rollers of the first roller series are cantilevered from a first side of the track frame, and the rollers of the second roller series are cantilevered from a second side of the track frame.

4. The roller system of claim 1, wherein the rollers of the first roller series are in a first substantially linear array, and the rollers of the second roller series are in a second substantially linear array that is substantially parallel to the first substantially linear array, the diameter of each roller of the first and second substantially linear arrays being greater than the distance between adjacent rollers of either of the first and second substantially linear arrays.

5. The roller system of claim 1, wherein each track shoe of the track shoe series includes a first rail surface and a second rail surface, and wherein the rollers of the first roller series are configured to engage the first rail surface, and the rollers of the second roller series are configured to engage the second rail surface.

6. The roller system of claim 5, wherein adjacent rollers of the first roller series are configured to engage first rail surfaces of alternate, non-adjacent track shoes of the track shoe series, and wherein adjacent rollers of the second roller series are configured to engage second rail surfaces of track shoes of the track shoe series that are between the alternate, nonadjacent track shoes.

7. The roller system of claim 1, wherein the first and second roller series are linear and the first roller series is parallel to and laterally adjacent the second roller series with rollers of the first roller series linearly spaced from laterally adjacent rollers of the second roller series, and wherein the spacing between adjacent track shoes of the track shoe series is substantially equal to the linear spacing between any roller of the first roller series and a laterally adjacent roller of the second roller series.

8. A track assembly, comprising:
a track frame;
a drive sprocket and at least one take-up idler mounted on the track frame;
an endless track including an interconnected track shoe series, the endless track mounted on the track frame and engaged with the drive sprocket and the at least one take-up idler;
a first roller series configured to simultaneously engage a first plurality of track shoes of the track shoe series; and
a second roller series configured to simultaneously engage a second plurality of track shoes of the track shoe series;
wherein the first plurality of track shoes is different from the second plurality of track shoes.

9. The track assembly of claim 8, wherein each track shoe includes at least two rail surfaces, and wherein the rollers of the first roller series engage a first of the two rail surfaces, and the rollers of the second roller series engage a second of the two rail surfaces.

10. The track assembly of claim 8, wherein the rollers of the first roller series are in a first substantially linear array and mounted to a first side of the track frame, and the rollers of the second roller series are in a second substantially linear array and mounted to a second side of the track frame, the first and second linear arrays being substantially parallel.

11. The track assembly of claim 10, wherein the endless track includes a lower run and at least one upper run, and the first and second roller series extend along the lower run for a combined distance D, wherein each track shoe within the combined distance D on the lower run is simultaneously engaged by one roller of one of the first and second roller series.

12. The track assembly of claim 11, wherein each roller rotates about an axis, and the axes of adjacent rollers of the first roller series are equally spaced apart a distance d along the first substantially linear array and the axes of adjacent rollers of the second roller series are equally spaced apart the same distance d along the second substantially linear array, and wherein the axes of the rollers of the first roller series are spaced apart along the combined distance D on the lower run from the axes of the rollers of the second roller series by approximately half the distance d.

13. The track assembly of claim 12, wherein each track shoe of the endless track along the combined distance D on the lower run is simultaneously engaged by a roller of one of the first and second roller series.

14. The track assembly of claim 8, wherein the distance between rollers of each of the first and second roller series is less than the diameter of the rollers and the distance between axes of rotation of adjacent rollers of each of the first and second roller series is approximately twice the distance between centers of adjacent track shoes of the track shoe series.

15. The track assembly of claim 8, wherein each roller of the first roller series is cantilevered from a first side of the track frame, and each roller of the second roller series is cantilevered from a second side of the track frame, and wherein the first roller series is offset longitudinally of the track frame relative to the second roller series.

16. A machine, comprising:
an upper body including a power source;
an undercarriage supporting the upper body and including a plurality of track assemblies, each track assembly including a track frame;
an endless track mounted on the track frame of each track assembly and including an interconnected track shoe series; and
wherein each track assembly includes:
a first roller series in a linear array wherein each roller is secured to the track frame for rotation about an axis;
a second roller series in a linear array parallel to the first roller series wherein each roller is secured to the track frame for rotation about an axis;
wherein the first roller series is offset longitudinally of the track frame relative to the second roller series such that the axes of the rollers of the first roller series are between the axes of the rollers of the second roller series.

17. The machine of claim 16, wherein the rollers of the first roller series are cantilevered from a first side of the track frame, and the rollers of the second roller series are cantilevered from a second side of the track frame.

18. The machine of claim 16, wherein the rollers of each of the first and second roller series are substantially equal in diameter, each roller of the first and second roller series being spaced from an adjacent roller of the respective first and second roller series a distance less than the diameter of the rollers.

19. The machine of claim 18, wherein, along the length of the parallel first and second roller series, the axis of each roller of the first roller series is centered between the axes of laterally adjacent rollers of the second roller series.

20. The machine of claim 16, wherein each track shoe of the interconnected track shoe series includes first and second grooves, a first rail surface within the first groove and a second rail surface within the second groove, and wherein rollers of the first roller series engage the first rail surface, and rollers of the second roller series engage the second rail surface.
